(19) United States
(12) Patent Application Publication
(10) Pub. No.: US 2022/0114656 A1
(43) Pub. Date: Apr. 14, 2022

(54) INFORMATION PROCESSING APPARATUS, METHOD OF INFORMATION PROCESSING, AND TERMINAL APPARATUS

(71) Applicant: Toyota Jidosha Kabushiki Kaisha, Toyota-shi Aichi-ken (JP)

(72) Inventors: Ai Miyata, Okazaki-shi (JP); Ryosuke Tanimura, Nisshin-shi (JP)

(73) Assignee: Toyota Jidosha Kabushiki Kaisha, Toyota-shi Aichi-ken (JP)

(21) Appl. No.: 17/379,343

(22) Filed: Jul. 19, 2021

(30) Foreign Application Priority Data
Oct. 8, 2020 (JP) 2020-170803

(51) Int. Cl. G06Q 30/06; G06F 9/451

(52) U.S. Cl. CPC G06Q 30/0645; G06F 9/451

(57) ABSTRACT

An information processing apparatus includes a control unit. The control unit acquires information about stations belonging to a first station group and information about stations belonging to a second station group, outputs the information about the stations, and acquires information about stations selected by the user as a rental station and as a return station. The control unit acquires information that identifies a first select station and information that identifies a first select station. The control unit restricts, when the user selects the second select station, selection of the second select station from stations belonging to the station group that is different from the station group of the first select station.

### CROSS-REFERENCE TO RELATED APPLICATION

This application claims priority to Japanese Patent Application No. 2020-170803 filed on Oct. 8, 2020, incorporated herein by reference in its entirety.

### BACKGROUND

### 1. Technical Field

The present disclosure relates to an information processing apparatus, a method of information processing, and a terminal apparatus.

### 2. Description of Related Art

Conventionally, a service has been known which enables a user to reserve the use of car sharing by specifying a place of departure and a destination. For example, Unexamined Japanese Patent Application Publication No. 2019-152978 discloses an apparatus that generates recommendation information including a rental place and a return place of a vehicle subject to car sharing, based on a search instruction including a purpose and a movement start position input by the user and that presents the generated recommendation information to the user.

### SUMMARY

When a user selects a renting place and a return place of a mobile object, it is necessary to manage a storage place of the mobile object. Rental companies of the mobile objects require reduced load of managing the mobile objects. Users who rent the mobile objects require convenient use of the service. In other words, it is required to enhance the convenience of the service for renting the mobile objects.

An object of the present disclosure made in view of these circumstances is to enhance the convenience of service for renting a mobile object.

An information processing apparatus according to an embodiment of the present disclosure includes a control unit. The control unit is configured to acquire information about stations belonging to a first station group where a rental condition of a mobile object to a user is a first rental condition and information about stations belonging to a second station group where the rental condition of the mobile object to the user is a second rental condition, output the information about the stations, and acquire information about stations selected by the user as a rental station for renting the mobile object to the user and as a return station for the user to return the mobile object. The control unit is configured to acquire information that identifies a first select station that is one of the rental station and the return station selected by the user first, and information that identifies a second select station that is one of the rental station and the return station selected by the user later. The control unit is configured to restrict, when the user selects the second select station, selection of the second select station from stations belonging to a station group that is different from the station group of the first select station.

A method of information processing according to an embodiment of the present disclosure includes: acquiring information about stations belonging to a first station group where a rental condition of a mobile object to a user is a first rental condition and information about stations belonging to a second station group where the rental condition of the mobile object to the user is a second rental condition, outputting the information about the stations, acquiring information about stations selected by the user as a rental station for renting the mobile object to the user and as a return station for the user to return the mobile object, acquiring information that identifies a first select station that is one of the rental station and the return station selected by the user first, and information that identifies a second select station that is one of the rental station and the return station selected by the user later, and restricting, when the user selects the second select station, selection of the second select station from stations belonging to a station group that is different from the station group of the first select station.

An information processing apparatus according to an embodiment of the present disclosure includes a control unit. The control unit is configured to output information about stations belonging to a first station group where a rental condition of a mobile object to a user is a first rental condition and information about stations belonging to a second station group where the rental condition of the mobile object to the user is a second rental condition, accept input of the user selecting a rental station for renting the mobile object to the user and a return station for the user to return the mobile object, and output information about the stations selected by the user. The control unit is configured to output the information about the stations such that a first select station that is one of the rental station and the return station selected by the user first is selectable from stations belonging to the first station group and stations belonging to the second station group. The control unit is configured to output the information about the stations such that a second select station that is one of the rental station and the return station selected by the user later is unselectable from stations belonging to a station group that is different from the station group of the first select station.

The information processing apparatus, the method of information processing, and the terminal apparatus according to an embodiment of the present disclosure can enhance the convenience of service for renting a mobile object.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration example of a mobile object management system according to an embodiment;

FIG. 2 shows an example of stations map-displayed in a terminal apparatus;

FIG. 3 shows an example of the stations list-displayed in the terminal apparatus;

FIG. 4 shows a display example where selection of the stations is restricted in map display;

FIG. 5 shows an example of displaying the stations selectable in the list display;

FIG. 6 shows a display example where selection of the stations is restricted in list display;

FIG. 7 is a flowchart showing an example of procedures of a method of information processing according to an embodiment;

FIG. 8 is a flowchart showing an example of procedures of a method of terminal control according to an embodiment; and

FIG. 9 is a flowchart showing an example of procedures for accepting input of application.

### DETAILED DESCRIPTION OF EMBODIMENTS

Configuration Example of Mobile Object Management System 1

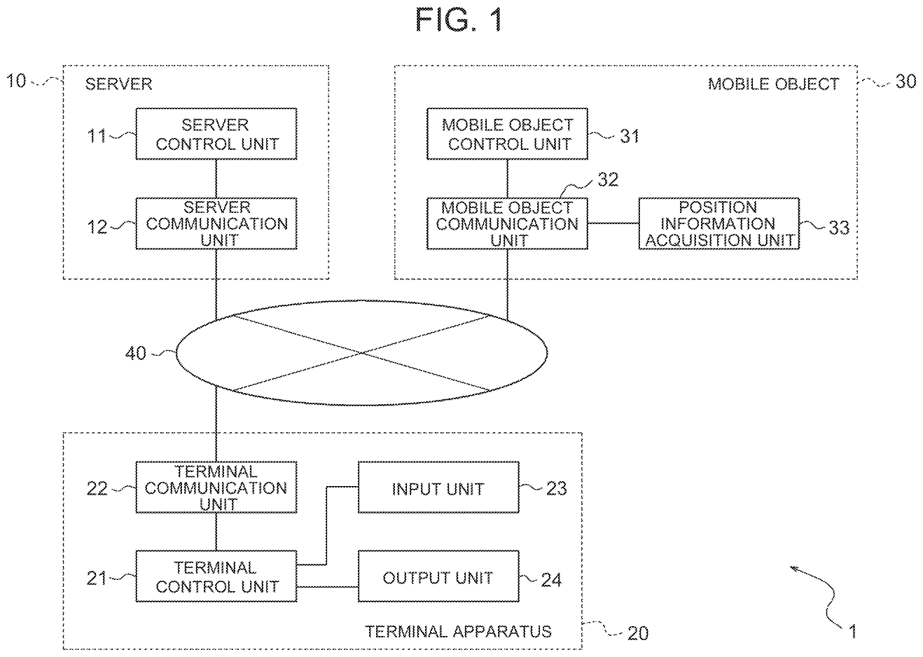

As shown in FIG. 1, a mobile object management system 1 according to an embodiment includes a server 10, a terminal apparatus 20, and a mobile object 30. The server 10, the terminal apparatus 20, and the mobile object 30 can communicate with each other through a network 40. The numbers of the servers 10, the terminal apparatuses 20 and the mobile objects 30 are not limited to one. The number may be two or more.

The mobile object management system 1 provides a service to rent the mobile object 30 to a user. The service to rent the mobile object 30 to the user is also known as a rental service. The server 10 processes information about the mobile object 30 that is rented to the user. The terminal apparatus 20 accepts rental application for the mobile object 30 from the user.

Hereinafter, configuration examples of the mobile object management system 1 used to provide the rental service will be described.

Server 10

The server 10 includes a server control unit 11, and a server communication unit 12.

The server control unit 11 controls each component unit of the server 10. The server control unit 11 is also simply referred to as the control unit. The server control unit 11 may include one or more processors. In the present embodiment, the “processor” is a general-purpose processor, a special-purpose processor dedicated for specific processing, or the like. However, the “processor” is not limited to these. The server control unit 11 may include one or more dedicated circuits. The dedicated circuit may include, for example, a field-programmable gate array (FPGA), an application specific integrated circuit (ASIC), or the like. The server control unit 11 may be configured to include a dedicated circuit instead of a processor, or may be configured to include both the processor and the dedicated circuit.

The server 10 may further include a storage unit. Although examples of the storage unit include a semiconductor memory, a magnetic memory, or an optical memory, the storage unit is not limited to these. The storage unit may function as a main storage, an auxiliary storage, or a cache memory, for example. The storage unit may include an electromagnetic storage medium, such as a magnetic disk. The storage unit stores any information that is used for operation of the server 10. For example, the storage unit may store information such as system programs or application programs. The storage unit may be included in the server control unit 11.

The server communication unit 12 includes a communication module that is configured to be communicable with the terminal apparatus 20 or the mobile object 30 via the network 40. The server communication unit 12 is also simply referred to as the communication unit.

The server 10 may include one or more server apparatuses communicable with each other. The server 10 is also referred to as the information processing apparatus.

Terminal Apparatus 20

The terminal apparatus 20 includes a terminal control unit 21, a terminal communication unit 22, an input unit 23, and an output unit 24. Examples of the terminal apparatus 20 may include, for example, mobile terminals such as smartphones. Examples of the terminal apparatus 20 may include personal computers (PCs) such as notebook PCs or tablet PCs.

Without being limited to these examples, the terminal apparatus 20 may include various devices.

The terminal control unit 21 controls each component unit of the terminal apparatus 20. The terminal control unit 21 is also simply referred to as the control unit. The terminal control unit 21 may include one or more processors. The terminal control unit 21 executes programs that implement the functions of the terminal apparatus 20. The terminal control unit 21 may have a configuration identical or similar to the server control unit 11. The terminal control unit 21 may be configured to include a storage unit.

The terminal communication unit 22 may be configured to include a communication module that is configured to be communicable with the server 10 via the network 40. Although the communication module may include a communication module in conformity with, for example, 4th generation (4G) or 5th generation (5G) mobile object communication standards, the communication module is not limited to these. The terminal communication unit 22 is also simply referred to as the communication unit.

The input unit 23 is configured to include an input device which receives input from the user. The input device may be configured to include, for example, a touchscreen panel or a touch sensor, or a pointing device such as a mouse. The input device may be configured to include a physical key. The input device may be configured to include an audio input device such as a microphone.

The output unit 24 outputs information to allow the user to recognize the information. The output unit 24 may be configured to include, for example, a display device that outputs visual information, such as images or text or figures. The display device may be configured to include, for example, a liquid crystal display (LCD), an organic electroluminescence (EL) display, or an inorganic EL display, or a plasma display panel (PDP). The display device is not limited to these displays. The display device may be configured to include other displays of various types. The display device may be configured to include a light emitting device such as light emitting diodes (LEDs). The display device may be configured to include various other devices.

The output unit 24 may be configured to include, for example, an audio output device that outputs audio information, such as voice. Without being limited to these examples, the output unit 24 may include various other devices.

Mobile Object 30

The mobile objects 30 may include four-wheel vehicles such as automobiles. The mobile objects 30 may include motorcycles such as bicycles or bikes, and may include tricycles. The mobile objects 30 may include personal mobility (movable bodies) such as HA: mo (registered trademark). Without being limited to these examples, the mobile objects 30 may include various vehicles on which users can ride.

The mobile object 30 includes a mobile object control unit 31, and a mobile object communication unit 32. The mobile object control unit 31 and the mobile object communication unit 32 are communicably connected with each other through, for example, an in-vehicle network such as a controller area network (CAN) or a leased line.

The mobile object control unit 31 controls each component unit of the mobile object 30. The mobile object control unit 31 is also simply referred to as the control unit. The mobile object control unit 31 may include one or more processors. The mobile object control unit 31 may include at least one of a dedicated circuit instead of a processor, or may include both the processor and at least one of the dedicated circuit. The mobile object control unit 31 may be configured to further include a storage unit.

The mobile object communication unit 32 may be configured to include a communication module that is configured to be communicable with the server 10 via the network 40. Although the communication module may include a communication module in conformity with, for example, 4G or 5G mobile object communication standards, the communication module is not limited to these. The mobile object communication unit 32 may be configured to include, for example, an in-vehicle communicator. The mobile object communication unit 32 is also simply referred to as the communication unit.

The mobile object 30 further includes a position information acquisition unit 33, though the position information acquisition unit 33 is not essential. The position information acquisition unit 33 is communicably connected with the mobile object control unit 31 or the mobile object communication unit 32 through an in-vehicle network such as CAN or a leased line. The position information acquisition unit 33 acquires information on the position of the mobile object 30 itself. The position information acquisition unit 33 may include a receiver corresponding to a global positioning system (GPS). For example, the receiver corresponding to the GPS may include a GPS receiver. The mobile object 30 may output its own position information acquired by the position information acquisition unit 33 to the server 10 from the mobile object communication unit 32.

The mobile object 30 may be configured to be driven by the user. The mobile object 30 may be configured to be operable by automated driving. The automated driving may be carried out, for example, in any one of levels 1 to 5 defined by Society of Automotive Engineers (SAE). The automated driving is not limited to the illustrated definitions. The automated driving may be carried out based on other definitions. When the mobile object 30 is controlled by automated driving, the mobile object control unit 31 controls travel of the mobile object 30. By specifying a destination for the mobile object 30, the user can travel to the destination by riding on the self-driving mobile object 30.

Operation Examples of Rental Service

Hereinafter, operation examples of the rental service will be described.

In the present embodiment, the rental service is provided by at least two different operation entities. In other words, in the present embodiment, at least two different rental services are provided. Each of the operation entities rent their own mobile objects 30 to users. Each of the operation entities rent their own mobile objects 30 to the users based on conditions set by the respective operation entities. The conditions set forth by the operation entities include at least rental of the mobile objects 30 owned by the respective operation entities to the users. Therefore, the conditions set forth by the respective operation entities are different from each other at l1 in that the mobile objects 30 rented to the users in the rental services provided by the respective operation entities are different. At least some of the operation entities may be organized as franchises.

At least two operation entities include a first operation entity and a second operation entity, respectively. In other words, the first operation entity and the second operation entity operate their rental services on conditions different from each other. The first operation entity and the second operation entity rent the mobile objects 30 to the users based on a first rental condition and a second rental condition, respectively. The first rental condition and the second rental condition are different from each other.

The first operation entity manages the mobile objects 30 to be rented to the users based on the first rental condition. The second operation entity manages the mobile objects 30 to be rented to the users based on the second rental condition. In other words, the first rental condition is applied to the rental of the mobile objects 30 managed by the first operation entity. The second rental condition is applied to the rental of the mobile objects 30 managed by the second operation entity. The rental condition may include a condition to limit the location of renting the mobile object 30 and a condition to limit the location of returning the mobile object 30. The rental condition may include a condition relating to the rental period of the mobile object 30. The rental condition may include a condition relating to a rental fee of the mobile object 30. The first rental condition and the second rental condition may be at least partially coincide or may be completely different. The first rental condition and the second rental condition are simply referred to as the rental conditions unless they are required to be distinguished from each other.

Station Storing Mobile Objects 30

In the present embodiment, a user can apply for rental of the mobile object 30 to each of the operation entities based on the condition specified by each operation entity. The user can apply for rental of the mobile object 30 by specifying at least one of a point to rent the mobile object 30 and a point to return the mobile object 30. The user may specify one of the storage points where the operation entities store the mobile objects 30 as a rental point of the mobile object 30 or a return point of the mobile object 30.

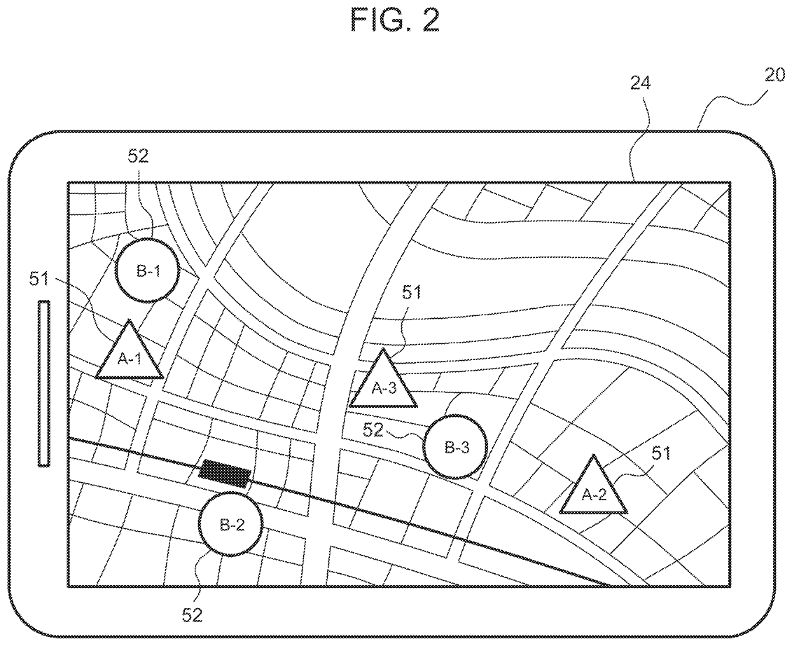

The first operation entity and the second operation entity manage first stations 51 and second stations 52 (see FIG. 2) for storing the mobile objects 30, respectively. In other words, the first stations 51 store the mobile objects 30 owned by the first operation entity. The second stations 52 stores the mobile objects 30 owned by the second operation entity. The first stations 51 and the second stations 52 are simply referred to as the stations unless they are required to be distinguished from each other. The user may specify one of the storage points where the operation entities store the mobile objects 30 as a rental point of the mobile object 30 or a return point of the mobile object 30.

The first stations 51 and the second stations 52 belong to a first station group and a second station group, respectively. Hence, the stations belonging to the first station group are referred to as the first stations 51. The stations belonging to the second station group are referred to as the second stations 52. The first station group and the second station group are simply referred to as the station groups unless they are required to be distinguished from each other.

Each of the operation entities basically stores the mobile objects 30 in the stations managed by each of the operation entities, that is, in the stations belonging to the identical station group. When renting the mobile object 30 to a user, each of the operation entities basically rents the mobile object 30 to the user on condition that the station for renting the mobile object 30 to the user and the station for the user to return the mobile object 30 belong to the identical station group.

Each of the operation entities may store the mobile objects 30 managed by other operation entities in the stations managed by each of the operation entities based on contracts between the operation entities. Each of the operation entities may rent the mobile object 30 to the user based on the contracts between the operation entities, even when the station for renting the mobile object 30 to the user and the station for the user to return the mobile object 30 belong to the station groups different from each other.

Operation of Mobile Object Management System 1

The mobile object management system 1 allows unitary management of the rental service provided by each of the operation entities by processing information about the operation of the rental service provided by each of the operation entities and processing information about the mobile objects 30 owned by each of the operation entities.

As a comparative example, a system may be considered which processes only the information about the operation of the rental service provided by a single operation entity. In the case where a user applies for rental of the mobile object 30 in the system according to the comparative example, the user can select the station for renting the mobile object 30 or the station for returning the mobile object 30 only from the stations managed by the operation entity using the pertinent system. When the user desires a point located within a prescribed range as the point for renting the mobile object 30 to the user or the point for the user to return the mobile object 30, the operation entity can rent the mobile object 30 to the user only when the station or stations managed by the operation entity is present within the prescribed range. In the case where a station managed by another operation entity is located within the prescribed range including the points that the user desires as the point for renting the mobile object 30 to the user and the point for the user to return the mobile object 30, the user needs to apply for rental of the mobile object 30 again in another system that is used by another operation entity. The mobile object management system 1 according to the present embodiment increases the possibility that any one of the operation entities is present with the prescribed range including the points that the user desires as the point for the user to rent the mobile object 30 and the point for the user to return the mobile object 30. Therefore, it becomes easier for the user to complete application for the mobile object 30 in a single system. As a result, the system becomes more convenient for the user.

Hereinafter, the operation executed by each component in order to implement the rental service in the mobile object management system 1 will be described.

The server 10 acquires information about the stations managed by the respective operation entities. The information about the stations includes information about the mobile objects 30 stored in the stations. The information about the stations includes information about the space of the stations for storing the mobile objects 30. The information about the stations includes information about station groups to which the stations belong. The information about the stations is also referred to as the station information. The information about the station group is also referred to as the station group information. The server 10 may acquire the station information or the station group information from each of the operation entities. Specifically, the server 10 may acquire data input by operators of each operation entity as the station information or the station group information. When the operation entity is a franchise, the server 10 may acquire the station information or the station group information from the franchisee.

The server 10 may acquire position information on the mobile objects 30. The server 10 may determine whether the mobile objects 30 are stored in the stations based on the position information on the mobile objects 30. The server 10 may identify the stations where the mobile objects 30 are each stored based on the position information on the mobile objects 30.

The server 10 acquires information about rental application for the mobile object 30 from a user, from the terminal apparatus 20 described later. The information about the rental application for the mobile object 30 is also referred to as the application information. The application information includes information about the point or range in which the user desires to rent the mobile object 30, or the point or range in which the user desires to return the mobile object 30. The application information may include information that specifies the operation entity to which the user makes a request for renting the mobile object 30.

The server 10 determines whether to accept the user's application based on the application information. When accepting the user's application, the server 10 determines the station for renting the mobile object 30 to the user and the station for the user to return the mobile object 30. The server 10 allocates the mobile object 30 to be rented to the user from the mobile objects 30 stored or scheduled to be stored in the station for renting the mobile object 30 to the user. When the server 10 accepts the user's application, the server 10 outputs to the terminal apparatus 20 the information about the station for renting the mobile object 30 to the user.

The server 10 may be operated by a single operation entity. The server 10 may be operated jointly by two or more operation entities.

The terminal control unit 21 of the terminal apparatus 20 acquires the station information from the server 10 with the terminal communication unit 22. The terminal control unit 21 notifies the user of the station information by making the output unit 24 output the station information. The terminal control unit 21 accepts rental application for the mobile object 30 from the user with the input unit 23. The terminal control unit 21 may run an application that is for accepting the rental application of the mobile object 30 from the user.

The terminal control unit 21 accepts input of information indicating the point or range in which the mobile object 30 is rented and the point or range in which the mobile object 30 is returned as the rental application for the mobile object 30. The terminal control unit 21 may enable the user to input the rental application with the input unit 23, while outputting the station information to the user via the output unit 24 to allow the user to view the information. The terminal control unit 21 generates application information based on the input of the application by the user and outputs the generated information from the terminal communication unit 22 to the server 10. The terminal control unit 21 acquires the information that identifies the mobile object 30 to be rented to the user from the server 10 with the terminal communication unit 22, and notifies the user of the information.

The terminal apparatus 20 is possessed by the user. The terminal apparatus 20 may be placed at a prescribed location to allow access of at least one user.

The terminal control unit 21 allows the user to select the station to rent the mobile object 30 or the station to return the mobile object 30 as the input of the rental application of the mobile object 30 by the user. The station to rent the mobile object 30 to the user is also referred to as a rental station. The station to return the mobile object 30 to the user is also referred to as a return station.

The terminal control unit 21 accepts input to select the station from the user with the input unit 23. The terminal control unit 21 may accept input of information that identifies which station the user selects first, the rental station or the return station, with the input unit 23. The terminal control unit 21 can confirm selection of one station out of the rental station and the return station by identifying which station the user selects first, the rental station or the return station, and then accepting input to select the station from the user. The terminal control unit 21 can confirm the selection of the rental station and the return station by accepting the input to select one station and then identifying which station the user selects first, the rental station or the return station. The station selected by the user first, out of the rental station and the return station, is also referred to as a first select station. The station selected by the user later, out of the rental station and the return station, is also referred to as a second select station.

The terminal control unit 21 displays station information with the output unit 24 such that the user can view the station information to select the station.

The output unit 24 is configured as a display of the terminal apparatus 20 as shown in FIG. 2, for example. The output unit 24 may display the first stations 51 belonging to the first station group and the second stations 52 belonging to the second station group on top of the map displayed on the display. In other words, the output unit 24 may display the stations on the map. The first stations 51 are displayed as A-1, A-2, A-3. The second stations 52 are displayed as B-1, B-2, B-3. The number of the station groups is not limited to two. The number may be three or more. The number of stations belonging to each station group is not limited to three. The number may be two or less, and may be four or more.

The terminal control unit 21 may accept the input to select the station from the user with the input unit 23. In the example shown in FIG. 2, the input unit 23 is configured as a touchscreen panel for the terminal apparatus 20. The input unit 23 accepts input to select the station when the user touches the station displayed on the map.

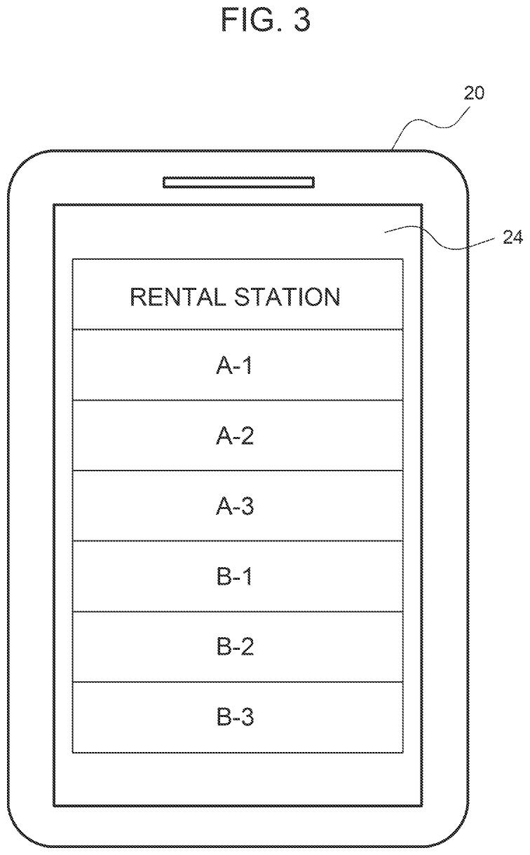

The output unit 24 may display the stations as a list as shown in FIG. 3, for example. In short, the output unit 24 may display a station list. In the example shown in FIG. 3, the output unit 24 displays a list of stations to enable the user to select the rental station. The output unit 24 may display a list of stations to enable the user to select the return station.

The terminal control unit 21 outputs information about the rental station and the return station selected by the user to the server 10 from the terminal communication unit 22. The server 10 determines whether to permit or reject rental application for the mobile object 30 based on the rental station and the return station selected by the user. The terminal control unit 21 acquires information about determination regarding permission or rejection of the application from the server 10 with the terminal communication unit 22, and notifies the user of the information with the output unit 24.

In the present embodiment, the server 10 basically permits rental application for the mobile object 30 when the rental station and the return station belong to the same station group. The server 10 may permit the rental application for the mobile object 30 when the station group to which the rental station selected by the user belongs coincides with the station group to which the return station selected by the user belongs. When the station group to which the rental station belongs coincides with the station group to which the return station belongs, the mobile objects 30 managed by the operation entities are stored in the stations managed by the corresponding operation entities. As a result, it becomes easier for each operation entity to manage the mobile objects 30.

Operation to Restrict Selection of Station

The terminal control unit 21 may restrict selection of the second select station after the user selects the first select station. When, for example, the user selects the first select station from the first station group, the terminal control unit 21 may restrict or prohibit selection of the second select station from the second station group. The terminal control unit 21 may permit selection of the second select station from the first select station group. When receiving input of selection by the user, the terminal apparatus 20 may restrict or prohibit, or permit the selection. This discourages the user from selecting the station that does not meet conditions, and saves the user from redoing input of application. As a result, user's convenience is enhanced.

The terminal control unit 21 may restrict selection of the second select station by the user by controlling an output aspect of the station information.

When the user selects the rental station first, the terminal control unit 21 makes the user select the return station next. In the present embodiment, the return station is basically selected from the station belonging to the station group identical to that of the rental station selected by the user first. The terminal control unit 21 may selectably display the station group to which the rental station selected first belongs with the output unit 24. The terminal control unit 21 may display on the output unit 24 only the stations belonging to the station group identical to that of the rental station selected first. The terminal control unit 21 may display on the output unit 24 the stations belonging to the station group identical to that of the rental station selected first in a selectable manner, while displaying on the output unit 24 the stations belonging to the station group different from that of the rental station selected first in an unselectable manner.

When the user selects the return station first, the terminal control unit 21 makes the user select the rental station next. In the present embodiment, the rental station is basically selected from the stations belonging to the station group identical to that of the return station selected first. The terminal control unit 21 may selectably display the station group to which the return station selected first belongs with the output unit 24. The terminal control unit 21 may display on the output unit 24 only the stations belonging to the station group identical to that of the return station selected first. The terminal control unit 21 may display on the output unit 24 the stations belonging to the station group identical to that of the return station selected first in a selectable manner, while displaying on the output unit 24 the stations belonging to the station group different from that of the return station selected first in an unselectable manner.

For example, when the user selects one of the second stations 52 as the first selection station, the output unit 24 displays the station information to disable the user from selecting one of the first stations 51 as the second selection station.

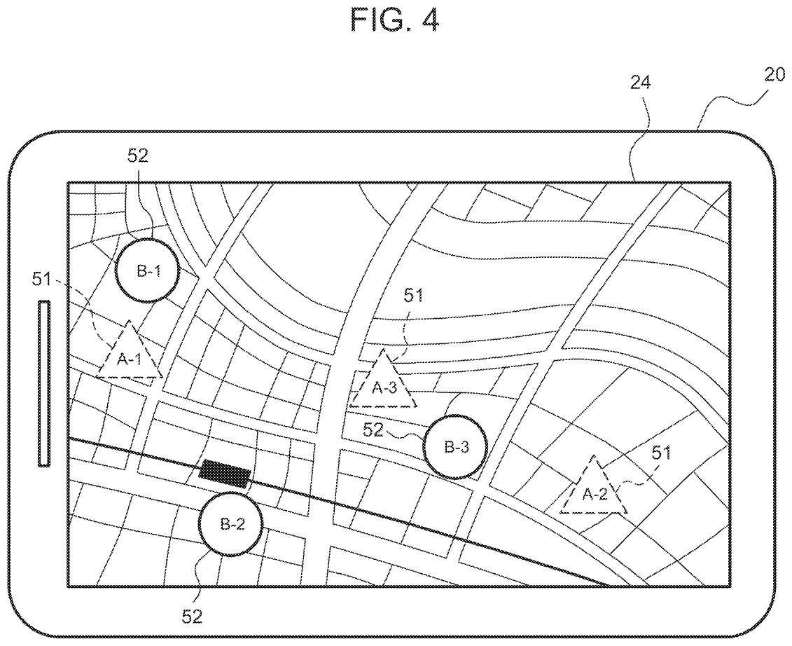

For example, as shown in FIG. 4, when the output unit 24 displays stations on a map, the output unit 24 may display the stations such that the first stations 51 and the second stations 52 are different in display aspect from each other. Specifically, the output unit 24 may display the stations to enable the user to distinguish between selectable and unselectable stations. In FIG. 4, the first stations 51 are displayed with a dashed outline to indicate that they are unselectable. The second stations 52 are displayed with a solid outline to indicate that they are selectable. This makes it easy for the user to recognize that only the second stations 52 (B-1, B-2, B-3) are selectable.

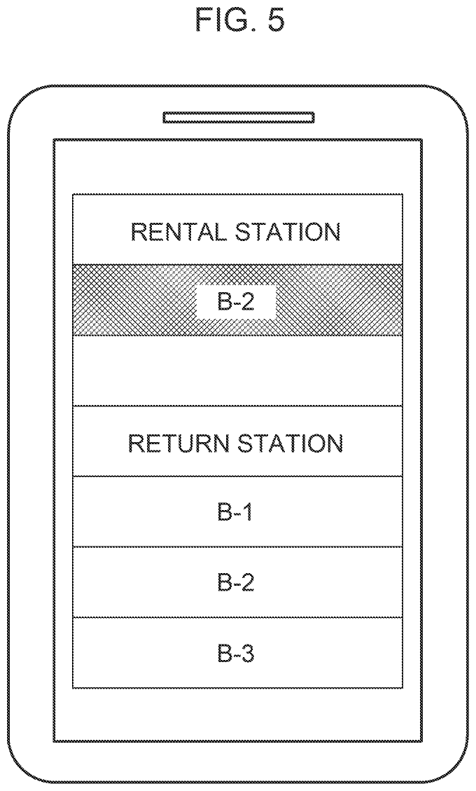

For example, as shown in FIG. 5, when the output unit 24 displays stations as a list, the output unit 24 may display only the second stations 52 without displaying the first stations 51. This makes it easy for the user to recognize that only the second stations 52 (B-1, B-2, B-3) are selectable.

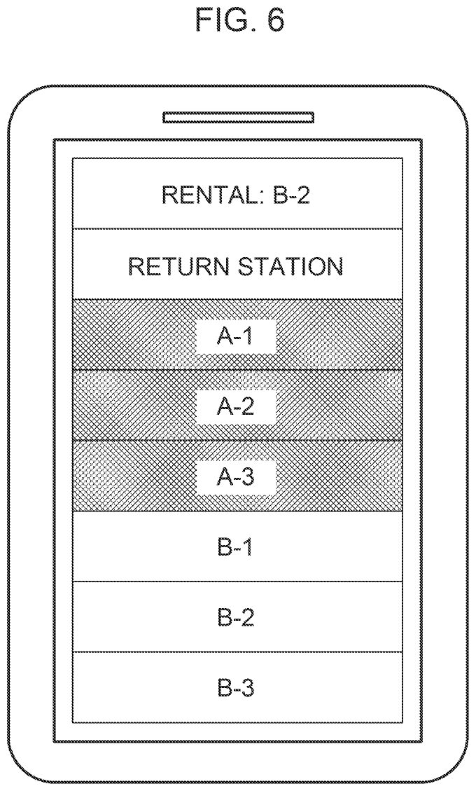

As shown in FIG. 6, for example, when the output unit 24 displays stations as a list, the output unit 24 may display the stations such that the first stations 51 and the second stations 52 are different in display aspect from each other. Specifically, the output unit 24 may display the stations to enable the user to distinguish between selectable and unselectable stations. In FIG. 6, the first stations 51 are displayed with hatching to indicate that they are unselectable. The second stations 52 are displayed without hatching to indicate that they are selectable. This makes it easy for the user to recognize that only the second stations 52 (B-1, B-2, B-3) are selectable.

The output unit 24 may display the stations so as to be distinguishable with the presence of hatching, and may also display the stations so as to be distinguishable with different display aspects. For example, the output unit 24 may display the stations so as to be distinguishable by differentiating colors or shapes of the figures representing the stations. The output unit 24 may display the stations so as to be distinguishable by differentiating colors or shapes of the characters representing the stations. The output unit 24 may display the stations so as to be distinguishable by differentiating text describing the stations.

The operation of the terminal control unit 21 to restrict selection of the station by the user is paraphrased as follows. The terminal control unit 21 outputs the station information such that a first select station that is one of the rental station and the return station selected by the user first is selectable from the stations belonging to the first station group and the stations belonging to the second station. The terminal control unit 21 outputs the station information such that a second select station that is one of the rental station and the return station selected by the user later is unselectable from the stations belonging to the station group that is different from the first station group.

The user can easily select the station when the terminal apparatus 20 outputs the station information so as to restrict selection of the second select station by the user. The user's rental application for the mobile object 30 is also less likely to be rejected due to station selection error. As a result, user's convenience is enhanced.

The restriction on selection of the second select station can be implemented as a function of the terminal apparatus 20 as well as a function of the server 10. Hereinafter, an example of the operation of the server 10 restricting selection of the second select station will be described.

The server control unit 11 outputs information about the stations belonging to the first station group and the second station group to the terminal apparatus 20. The server control unit 11 may output a flag in association with the station information, the flag permitting the user to select one of the stations belonging to the first station group and the stations belonging to the second station group as the first select station.

The server control unit 11 acquires information about the first select station selected by the user from the terminal apparatus 20. The server control unit 11 may output to the terminal apparatus 20 the information about stations belonging to the station group that is identical to that of the first select station, in association with a flag that permits selection as the second select station. The server control unit 11 may output to the terminal apparatus 20 the information about stations belonging to the station group that is different from that of the first select station, in association with a flag that restricts or prohibits selection as the second select station.

The terminal control unit 21 acquires the information that is the station information associated with the flag from the server 10. The output unit 24 displays the stations that are permitted to be selected as the second select station and the stations that are restricted or prohibited from being selected as the second select station in display aspects different from each other, based on the flag. In short, the output unit 24 displays the user selectable stations and the user unselectable stations in a distinguishable manner, based on the flag.

The operation of the server control unit 11 to restrict selection of the station by the user is paraphrased as follows. The server control unit 11 permits selection of the first select station that is one of the rental station and the return station selected by the user first, from the stations belonging to the first station group and the stations belonging to the second station group. The server control unit 11 restricts or prohibits selection of the second select station that is one of the rental station and the return station selected by the user later, from the stations belonging to the station group that is different from the first station group.

The server control unit 11 also acquires information about the return station as the second select station when the information about the rental station is acquired as the first select station. The server control unit 11 also acquires information about the rental station as the second select station when the information about the return station is acquired as the first select station.

As described in the foregoing, the load on the terminal apparatus 20 can be reduced by the server 10 processing the station information.

The mobile object management system 1 according to the present embodiment can process information about operation of the rental services provided by a plurality of operation entities, while processing information about the mobile objects 30 owned by the respective operation entities. In this manner, unitary management of the rental services provided by the respective operation entities is achieved.

The unitary management of a plurality of rental services makes it easier for the user to use the rental services. As a result, user's convenience is enhanced.

The mobile object management system 1 according to the present embodiment may display the station information so as to restrict selection of the station by the user. This discourages the user from selecting the station that does not meet conditions, and saves the user from redoing input of application. This means that the user can easily select the station. As a result, user's convenience is enhanced.

Examples of Method of Information Processing

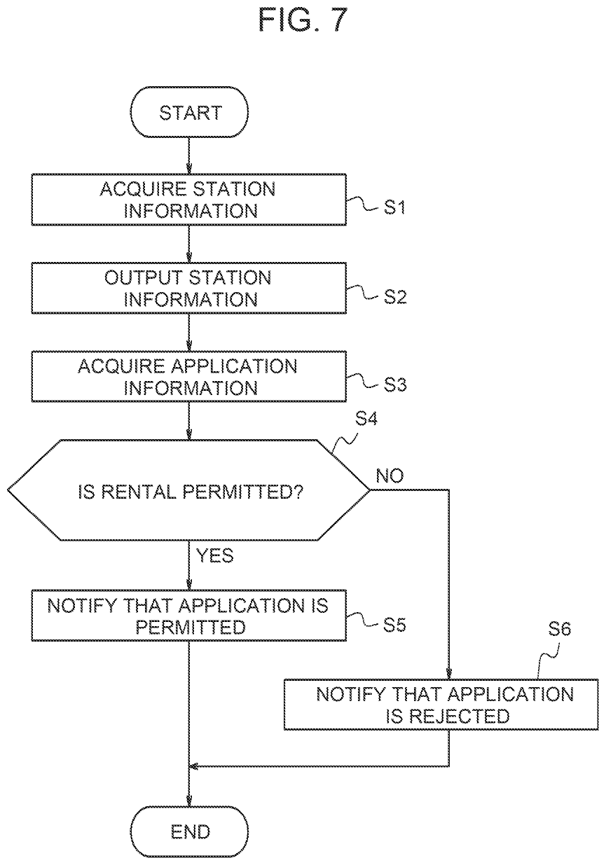

The server control unit 11 may execute a method of information processing including the procedures of a flowchart illustrated in FIG. 7. The method of information processing may be implemented as an information processing program executed by a processor that constitutes the server control unit 11.

The server control unit 11 acquires station information (step S1).

The server control unit 11 outputs station information to the terminal apparatus 20 (step S2).

The server control unit 11 acquires application information from the terminal apparatus 20 (step S3).

The server control unit 11 determines whether to permit rental of the mobile object 30 to the user based on the application information (step S4).

When the server control unit 11 permits rental of the mobile object 30 to the user (step S4: Yes), the server control unit 11 notifies that the application is permitted to the terminal apparatus 20 (step S5). After executing the procedure of step S5, the server control unit 11 ends execution of the procedures in the flowchart of FIG. 7.

When the server control unit 11 does not permit rental of the mobile object 30 to the user (step S4: No), the server control unit 11 notifies that the application is rejected to the terminal apparatus 20 (step S6). After executing the procedure of step S6, the server control unit 11 ends execution of the procedures in the flowchart of FIG. 7.

Example of Method of Terminal Control

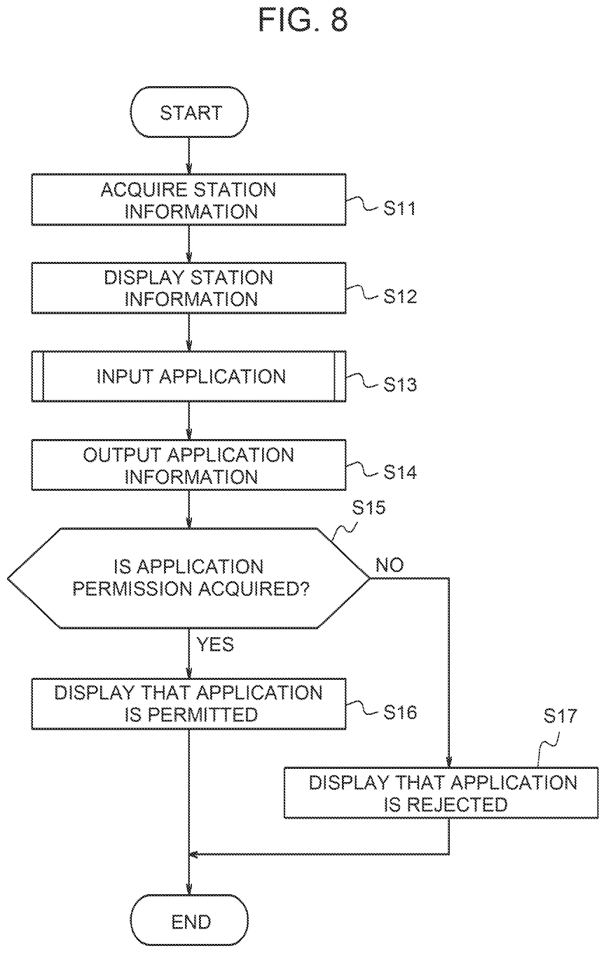

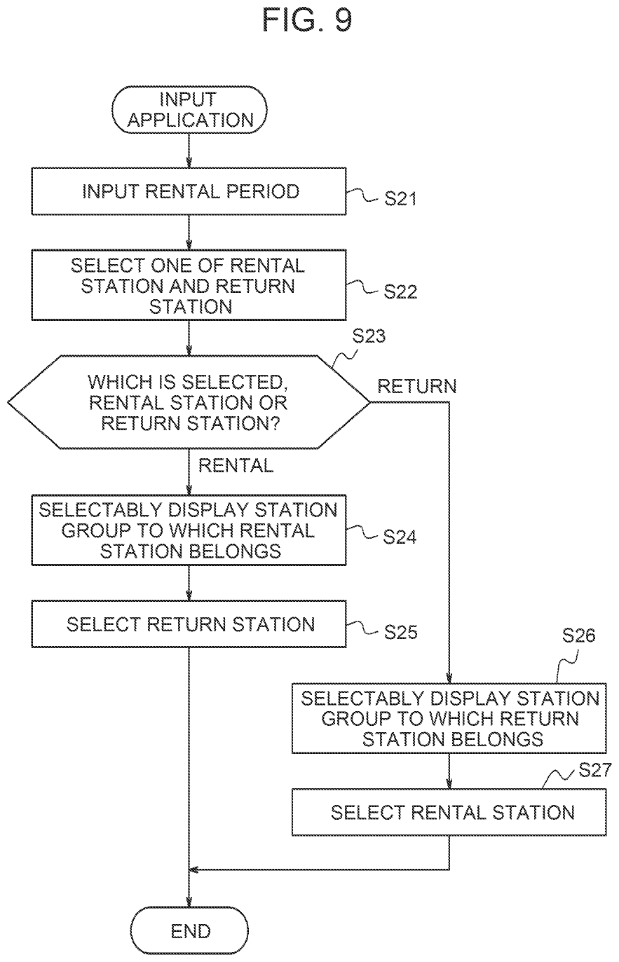

The terminal control unit 21 may execute a method of information processing including the procedures in flowcharts illustrated in FIGS. 8 and 9. The method of information processing may be implemented as an information processing program executed by the processor that constitutes the terminal control unit 21.

The terminal control unit 21 acquires station information from the server 10 (step S11).

The terminal control unit 21 displays the station information on the output unit 24 (step S12).

The terminal control unit 21 accepts input of rental application for the mobile object 30 from the user with the input unit 23 (step S13). The terminal control unit 21 may execute the procedures in the flowchart illustrated in FIG. 9 as the procedure of the step S13 as will be described later.

The terminal control unit 21 outputs application information based on input of application by the user (step S14).

The terminal control unit 21 determines whether the notification that the application is permitted is acquired from the server 10 (step S15).

When the terminal control unit 21 acquires the notification that the application is permitted from the server 10 (step S15: Yes), the terminal control unit 21 displays the notification that the application is permitted on the output unit 24 to notify the user (step S16). After executing the procedure of step S16, the terminal control unit 21 ends execution of the procedures in the flowchart of FIG. 8.

When the terminal control unit 21 does not acquire the notification that the application is permitted from the server 10 (step S15: No), the terminal control unit 21 displays the notification that the application is rejected on the output unit 24 to notify the user (step S17). After executing the procedure of step S17, the terminal control unit 21 ends execution of the procedures in the flowchart of FIG. 8.

The terminal control unit 21 may execute the procedures in the flowchart illustrated in FIG. 9 as a subroutine process for the input of the application in step S13.

The terminal control unit 21 accepts input of a desired rental period of the mobile object 30 from the user with the input unit 23 (step S21).

The terminal control unit 21 accepts input to select one of the rental station and the return station as the first select station from the user with the input unit 23 (step S22).

The terminal control unit 21 determines which station, the rental station or the return station, the user has selected as the first select station in the procedure of step S22 (step S23).

When determining that the user has selected the rental station as the first select station in the procedure of step S22 (step S23: “rental”), the terminal control unit 21 displays on the output unit 24 the stations in the station group to which the rental station belongs so as to enable the user to select as the return station (step S24).

The terminal control unit 21 accepts input to select the return station as the second select station from the user with the input unit 23 (step S25). After executing the procedure of step S25, the terminal control unit 21 ends execution of the procedures in the flowchart of FIG. 9, and returns to the procedure in step S14 of FIG. 8.

When determining that the user has selected the return station as the first select station in the procedure of step S22 (step S23: “return”), the terminal control unit 21 displays on the output unit 24 the stations in the station group to which the return station belongs so as to enable the user to select as the rental station (step S26).

The terminal control unit 21 accepts input to select the rental station as the second select station by the user with the input unit 23 (step S27). After executing the procedure of step S27, the terminal control unit 21 ends execution of the procedures in the flowchart of FIG. 9, and returns to the procedure in step S14 of FIG. 8.

The method of information processing and the method of terminal control according to the present embodiment allow unitary processing of the information about operation of the rental services provided by a plurality of operation entities. The unitary management of a plurality of rental services makes it easier for the user to use the rental services. As a result, user's convenience is enhanced.

The method of information processing and the method of terminal control according to the present embodiment make it possible to display the station information to restrict selection of the station by the user. This means that the user can easily select the station. As a result, user's convenience is enhanced.

### Other Embodiments

Restriction of Input with Input Unit 23

As described in the foregoing, when displaying the station information on the output unit 24, the terminal control unit 21 of the terminal apparatus 20 displays the stations to be selectable by the user or unselectable by the user. As a function of the input unit 23, the terminal control unit 21 may process the input of the user selecting selectable stations as valid input, or process the input of the user selecting unselectable stations as invalid input.

The terminal control unit 21 can display the stations on the output unit 24 such that the user can distinguish the unselectable stations by displaying them with a dashed outline as shown in FIG. 4, or with hatching as shown in FIG. 6. When there is input to select the station that is distinguishably displayed as an unselectable station, the terminal control unit 21 may make the input unit 23 process the input as invalid input. Conversely, when there is input to select the station that is distinguishably displayed as a selectable station, such as displayed with a solid outline or displayed without hatching, the terminal control unit 21 may make the input unit 23 process the input as valid input.

Since the input unit 23 determines whether an input content is valid or invalid, processing load can be distributed.

Exceptional Handling in Selection of Station

As described in the foregoing, the rental station and the return station are basically selected from the stations belonging to the identical station group. As a result, it becomes easier for the operation entity of the rental service to manage the mobile objects 30.

Meanwhile, each of the operation entities may store the mobile objects 30 managed by other operation entities in the stations managed by each of the operation entities based on the contracts between the operation entities. Each of the operation entities may rent the mobile object 30 to the user based on the contracts between the operation entities, even when the rental station and the return station belong to the station groups different from each other.

The mobile object management system 1 may allow the user to select the rental station and the return station such that the rental station and the return station belong to different stations based on the contracts between the operation entities, when a prescribed condition is satisfied. In other words, when the user selects the second select station, the server control unit 11 of the server 10 may cancel the restriction or prohibition on selection of the station belonging to the station group that is different from the station group of the first select station when a prescribed condition is satisfied.

The prescribed condition may include, for example, the user paying a fee that is different from a normal rental fee. The prescribed condition may include, for example, the user having used the rental system a predetermined number of times or more.

Without being limited to these examples, the prescribed condition may include various conditions.

By providing exceptions to the selection of the station by the user, user's choices are increased. As a result, user's convenience is enhanced.

Examples of Rental Aspect

Each of the operation entities may rent the mobile object 30 to the user such that the rental station and the return station coincide. The aspect of renting the mobile object 30 such that the rental station and the return station coincide is also referred to as a round scheme. In the case of renting the mobile object 30 in the round scheme, the server control unit 11 of the server 10 acquires information about the identical station as the rental station and the return station.

Each of the operation entities may rent the mobile object 30 to the user while allowing that the rental station is different from the return station. The aspect of renting the mobile object 30 while allowing that the rental station is different from the return station is also referred to as a one-way scheme. In the case of renting the mobile object 30 in the one-way scheme, the server control unit 11 of the server 10 acquires information about the stations different from each other as the information about the rental station and the return station.

In the case of renting the mobile object 30 in the one-way scheme, the operation entity may or may not limit the return station. The operation entity may, for example, limit the return station by the distance from the rental station. The operation entity may, for example, group the stations by region, and limit the return station such that the rental station and the return station are included in one group.

Configuration of Station Groups

The station groups may be configured such that only the stations managed by one operation entity belong to one station group. The station groups may be configured such that the stations managed by a plurality of operation entities belong to one station group.

The station groups may be configured such that only the stations that rent the mobile objects 30 in the round scheme belong thereto. The station groups may be configured such that only the stations that rent the mobile objects 30 in the one-way scheme belong thereto. The station groups may be configured for each region where the station is located.

The station groups may be configured based on rental conditions. For example, a first station group may be configured as a station group where the rental condition of the mobile object 30 to the user is a first rental condition. A second station group may be configured as a station group where the rental condition of the mobile object 30 to the user is a second rental condition. In other words, the stations belonging to the first station group may be configured to rent the mobile object 30 to the user under the first rental condition. The stations belonging to the second station group may be configured to rent the mobile object 30 to the user under the second rental condition. When the stations are displayed with the station groups being distinguishable, it becomes easier for the user to understand the rental condition when selecting the station. As a result, user's convenience is enhanced.

Content of Application Input

The terminal control unit 21 may further accept input of a rental period of the mobile object 30 as the rental application for the mobile object 30. The terminal control unit 21 outputs information about the period input by the user to the server 10 from the terminal communication unit 22. The server 10 may determine whether to permit or reject the rental application for the mobile object 30 based on the rental period of the mobile object 30. By accepting the input of the rental period, it becomes easier for each operation entity to manage the mobile objects 30.

While the embodiments according to the present disclosure have been described with reference to drawings and examples, it is to be understood that those skilled in the art can make various transformations and corrections based on the present disclosure. Therefore, it is to be noted that these transformations and corrections are intended to be embraced in the range of the present disclosure. For example, the functions, or the like, included in each means, step, or the like, can be rearranged without causing logical inconsistency, and a plurality of means, steps, or the like, can be integrated into unity or can be divided.

What is claimed is:

1. An information processing apparatus, comprising a control unit, the control unit being configured to:
acquire information about stations belonging to a first station group where a rental condition of a mobile object to a user is a first rental condition and information about stations belonging to a second station group where the rental condition of the mobile object to the user is a second rental condition;
output the information about the stations; and
acquire information about stations selected by the user as a rental station for renting the mobile object to the user and as a return station for the user to return the mobile object,
wherein the control unit is configured to acquire information that identifies a first select station that is one of the rental station and the return station selected by the user first, and information that identifies a second select station that is one of the rental station and the return station selected by the user later, and restrict, when the user selects the second select station, selection of the second select station from stations belonging to a station group that is different from the station group of the first select station.

2. The information processing apparatus according to claim 1, wherein the control unit permits selection of the second select station from the stations belonging to the station group that is identical to the station group of the first select station.

3. The information processing apparatus according to claim 1, wherein when the user selects the second select station, the control unit is configured to output the information about the stations belonging to the station group that is identical to the station group of the first select station, without outputting the information about the stations belonging to the station group that is different from the station group of the first select station.

4. The information processing apparatus according to claim 1, wherein: the control unit is configured to output the information about the stations by displaying the information on a terminal apparatus; and
when the user selects the second select station, the control unit is configured to display the information about the stations belonging to the station group that is identical to the station group of the first select station on the terminal apparatus, without displaying the information about the stations belonging to the station group that is different from the station group of the first select station on the terminal apparatus.

5. The information processing apparatus according to claim 1, wherein:
the control unit is configured to acquire information about the stations selected by the user based on input of the user that is accepted in a terminal apparatus; and
when the user selects the second select station, the control unit is configured to cause the terminal apparatus to process the input of the user selecting the station belonging to the station group that is identical to the station group of the first select station as valid input, and cause the terminal apparatus to process the input of the user selecting the station belonging to the station group that is different from the station group of the first select station as invalid input.

6. The information processing apparatus according to claim 1, wherein when the user selects the second select station, the control unit is configured to cancel restriction on selection of the station belonging to the station group that is different from the station group of the first select station when a prescribed condition is satisfied.

7. The information processing apparatus according to claim 1, wherein the control unit is configured to:
acquire information about the return station as the second select station when the information about the rental station as the first select station is acquired; and
acquire information about the rental station as the second select station when the information about the return station as the first select station is acquired.

8. The information processing apparatus according to claim 1, wherein the control unit acquires information about an identical station as the rental station and the return station.

9. A method of information processing, comprising:
acquiring information about stations belonging to a first station group where a rental condition of a mobile object to a user is a first rental condition and information about stations belonging to a second station group where the rental condition of the mobile object to the user is a second rental condition;
outputting the information about the stations;
acquiring information about stations selected by the user as a rental station for renting the mobile object to the user and as a return station for the user to return the mobile object;
acquiring information that identifies a first select station that is one of the rental station and the return station selected by the user first, and information that identifies a second select station that is one of the rental station and the return station selected by the user later; and
restricting, when the user selects the second select station, selection of the second select station from stations belonging to a station group that is different from the station group of the first select station.

10. The method according to claim 9, further comprising permitting selection of the second select station from the stations belonging to the station group that is identical to the station group of the first select station.

11. The method according to claim 9, further comprising outputting, when the user selects the second select station, the information about the stations belonging to the station group that is identical to the station group of the first select station, without outputting the information about the stations belonging to the station group that is different from the station group of the first select station.

12. The method according to claim 9, further comprising:
displaying the information about the stations; and
displaying, when the user selects the second select station, the information about the stations belonging to the station group that is identical to the station group of the first select station, without displaying the information about the stations belonging to the station group that is different from the station group of the first select station.

13. The method according to claim 9, further comprising:
acquiring information about the station selected by the user based on input of the user with an input unit;
processing, when the user selects the second select station, input of the user selecting the station belonging to the station group that is identical to the station group of the first select station as valid input; and
processing, when the user selects the second select station, input of the user selecting the station belonging to the station group that is different from the station group of the first select station as invalid input.

14. The method according to claim 9, further comprising canceling, when the user selects the second select station, restriction on selection of the station belonging to the station group that is different from the station group of the first select station when a prescribed condition is satisfied.

15. The method according to claim 9, further comprising:
acquiring information about the return station as the second select station when the information about the rental station as the first select station is acquired, and
acquiring information about the rental station as the second select station when the information about the return station as the first select station is acquired.

16. The method according to claim 9, further comprising acquiring information about an identical station as the rental station and the return station.

17. A terminal apparatus, comprising a control unit, the control unit being configured to:
output information about stations belonging to a first station group where a rental condition of a mobile object to a user is a first rental condition and information about stations belonging to a second station group where the rental condition of the mobile object to the user is a second rental condition;
accept input of the user selecting a rental station for renting the mobile object to the user and a return station for the user to return the mobile object; and
output information about the stations selected by the user,
wherein the control unit is configured to output the information about the stations such that a first select station that is one of the rental station and the return station selected by the user first is selectable from stations belonging to the first station group and stations belonging to the second station group, and output the information about the stations such that a second select station that is one of the rental station and the return station selected by the user later is unselectable from stations belonging to a station group that is different from the station group of the first select station.

18. The terminal apparatus according to claim 17, further comprising an output unit configured to display the information about the stations, wherein the output unit displays, when the user selects the second select station, the information about the stations belonging to the station group that is identical to the station group of the first select station, without outputting the information about the stations belonging to the station group that is different from the station group of the first select station.

19. The terminal apparatus according to claim 17, further comprising an input unit configured to accept input from the user, wherein the input unit is configured to process, when the user selects the second select station, input of the user selecting the station belonging to the station group that is identical to the station group of the first select station as valid input, and process the input of the user selecting the station belonging to the station group that is different from the station group of the first select station as invalid input.

20. The terminal apparatus according to claim 17, wherein the control unit is configured to output the information about the stations so as to enable the user to select the second select station from the stations belonging to the station group that is different from the station group of the first select station when a prescribed condition is satisfied.
